(19) United States
(12) Patent Application Publication
(10) Pub. No.: US 2009/0049967 A1
(43) Pub. Date: Feb. 26, 2009

(54) Hole punch structure

(76) Inventor: Chun-Yuan Chang, Taipei City (TW)

Correspondence Address: Chun-Yuan Chang, P.O. BOX 44 - 2049, Taipei, 10068, TW

(21) Appl. No.: 11/892,314

(22) Filed: Aug. 22, 2007

(51) Int. Cl. B26F 1/14

(52) U.S. Cl. 83/167; 83/588; 83/618; 83/633

(57) ABSTRACT

The invention provides a hole punch structure. More particularly, one end of an exposed longitudinal handle is moved together with a slide rod in a hole-punching mechanism covered by a casing. Thus, when the other end of the handle is pressed down, the slide rod is also moved transversely, a push rod connected to the slide rod is also moved, and a tool shelf is pressed vertically downward to achieve a hole-punching operation of a punching post. This hole punch structure works according to the principle of lever of the longitudinal handle and becomes a completely covered, laborsaving and safe hole-punching apparatus.

### BACKGROUND OF THE INVENTION

(1) Field of the Invention

The invention relates to a hole punch structure, in which a handle is pushed to move a slide rod to move transversely according to the principle of lever. In addition, a push rod moves a tool shelf vertically downward according to the combination relationship between the slide rod and the push rod so that the laborsaving hole-punching operation can be finished.

(2) Description of the Prior Art

FIG. 6 is a schematic illustration showing a conventional hole punch structure. As shown in FIG. 6, the typical hole punch structure is mainly composed of a pressing plate (81), a base (82), a spring (83) and a punching post (84). Pressing the pressing plate (81) can make the punching post (84) penetrate through an accommodating hole (85) so that the resilience of the spring (83) makes the pressing plate (81) recover to an original position and the hole-punching operation can be finished.

However, this kind of hole punch structure may be poorly designed and thus tends to hurt the users because the hole punch structure is not completely covered. If the user improperly uses this hole punch structure, he or she may be easily hurt by the exposed tool. In addition, the spring for recovering the pressing plate is also exposed outside, and thus tends to oxidize due to the humid climate. Thus, the conventional hole punch structure cannot satisfy the economic effectiveness and the utility, and cannot be regarded as a good one.

Furthermore, in the aspect of the mechanism of the typical hole punch, the user directly presses down the pressing plate to move the tool down. Actually, the hole punch cannot be used in a more laborsaving manner, and pressing the hole punch tends to make the wrist of the user have an ache. So, the user cannot use the hole punch continuously for a long period of time.

### SUMMARY OF THE INVENTION

In view of the associated problems induced by the design defects of the conventional hole punch structure, the present inventor has paid attention to the research and development according to the experience and the technology in manufacturing the associated products for many years, and thus developed this hole punch structure. The main object thereof is to design the mechanism by arranging a handle, a slide rod, a push rod, a tool shelf and a base and thus to achieve the laborsaving hole-punching operation. Furthermore, the special structures in the components can effectively prevent the tool from moving down so that the hole-punching operation of the punching post can be performed more precisely and smoothly.

Another object of the invention is to provide a casing to cover the hole punch for the purpose of preventing the internal components and the internal mechanism from being exposed outside and preventing the exposed tool from hurting the user. Also, it is possible to protect the internal mechanism of the hole punch structure from collision or damage so that the durability and the utility thereof can be enhanced.

The invention achieves the above-identified objects by providing a hole punch structure including a casing and a bottom cover connected to the casing to achieve the overall covering effect. In addition, one end of a longitudinal handle exposed from the casing is moved together with a slide rod. When the other end of the handle is pressed down, it can push the slide rod to move transversely and move a push rod connected to the slide rod. Meanwhile, a tool shelf is pressed vertically downward so that the object of punching the hole by a punching post is achieved.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a hole punch structure according to the invention.

FIG. 2 is a schematically exploded view showing the hole punch structure according to the invention.

FIG. 3 is a schematic illustration showing operations of the invention.

FIG. 4 is a first schematic illustration showing the embodiment of the invention.

FIG. 5 is a second schematic illustration showing the embodiment of the invention.

FIG. 6 is a schematic illustration showing a conventional hole punch structure.

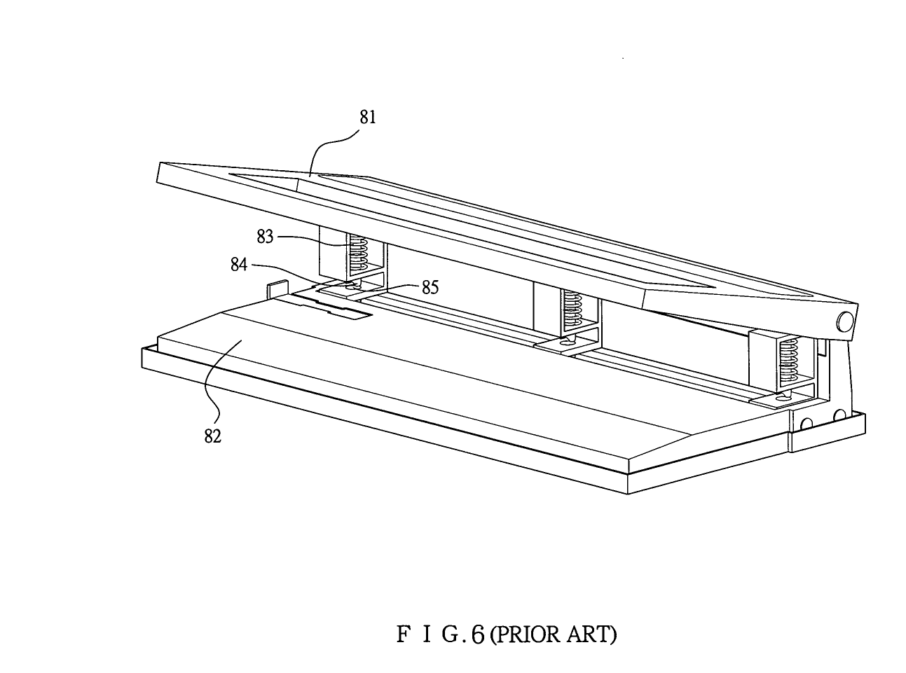

### DETAILED DESCRIPTION OF THE PREFERRED EMBODIMENTS

The structure, technological means and effects of the invention will be described with reference to the preferred embodiment in conjunction with the accompanying drawings.

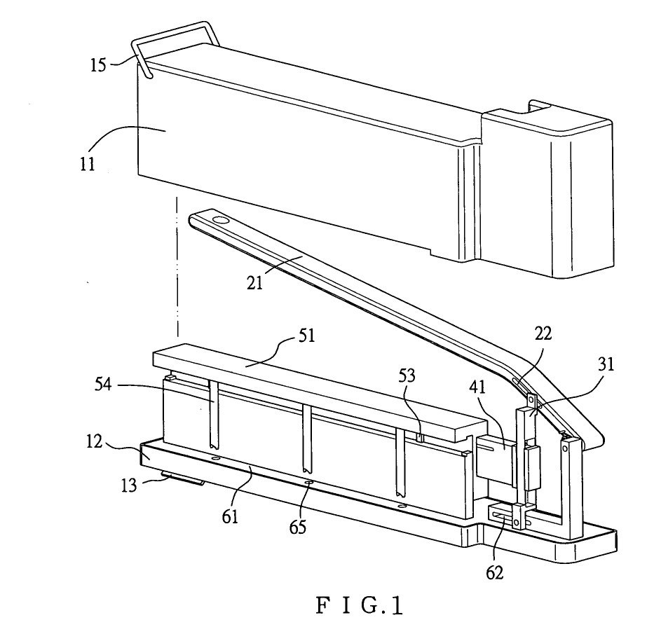

FIG. 1 is a schematic illustration showing a hole punch structure according to the invention. As shown in FIG. 1, the hole punch structure of the invention is mainly composed of a casing (11), a bottom cover (12), a handle (21), a slide rod (31), a push rod (41), a tool shelf (51) and a base (61). After the internal mechanism has been assembled, the overall mechanism is placed on the bottom cover (12), and then the casing (11) is mounted to cover the mechanism and thus to protect the internal mechanism and parts of the hole punch structure.

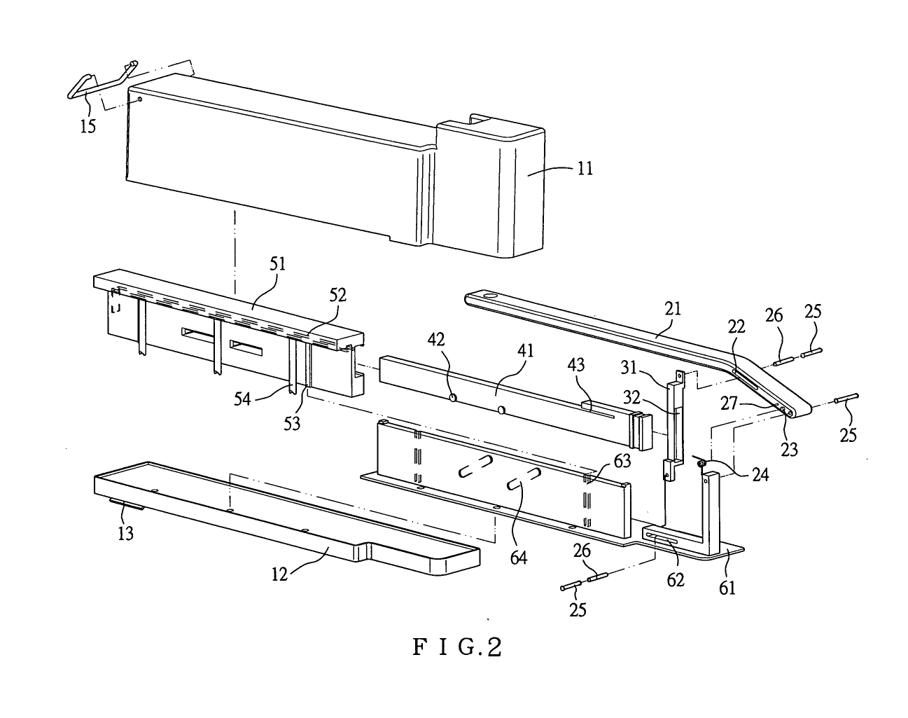

FIG. 2 is a schematically exploded view showing the hole punch structure according to the invention. As shown in FIG. 2, one end of the handle (21) is combined with the base (61) through a stationary shaft (25). A displacement groove (22) is formed on a handle. After the stationary shaft (25) is fit with a rotatable shaft (26), the combination of the stationary shaft (25) and the rotatable shaft (26) may be moved to-and-fro along the displacement groove (22) and thus move the slide rod (31) transversely. Furthermore, a torsional spring (24) is fit with a mounting projection (23) on the lateral side of the handle (21), and has one end pressing against a pressing rod (27). When the handle (21) is pressed down, an elastic recovering force may be provided so that the handle (21) can move back to the original position easily. Also, the slide rod (31) is tightly fit with the push rod (41) through an engaging slot (32). The push rod (41) and the tool shelf (51) are combined together by fitting a slit (43) formed in the push rod (41) with an engaging slot (52) of the tool shelf (51). The push rod (41) and the base (61) are combined together by fitting a circular projection (42) on the push rod (41) with a restricting slot (64) on the base (61). In addition, the tool shelf (51) and the base (61) are combined together by fitting a rectangular projection (53) on the tool shelf (51) with a rectangular slot (63) of the base (61). Finally, the push rod (41) and the base (61) having the restricting and aligning effects make the tool shelf (51) achieve the vertically downward pressing effect.

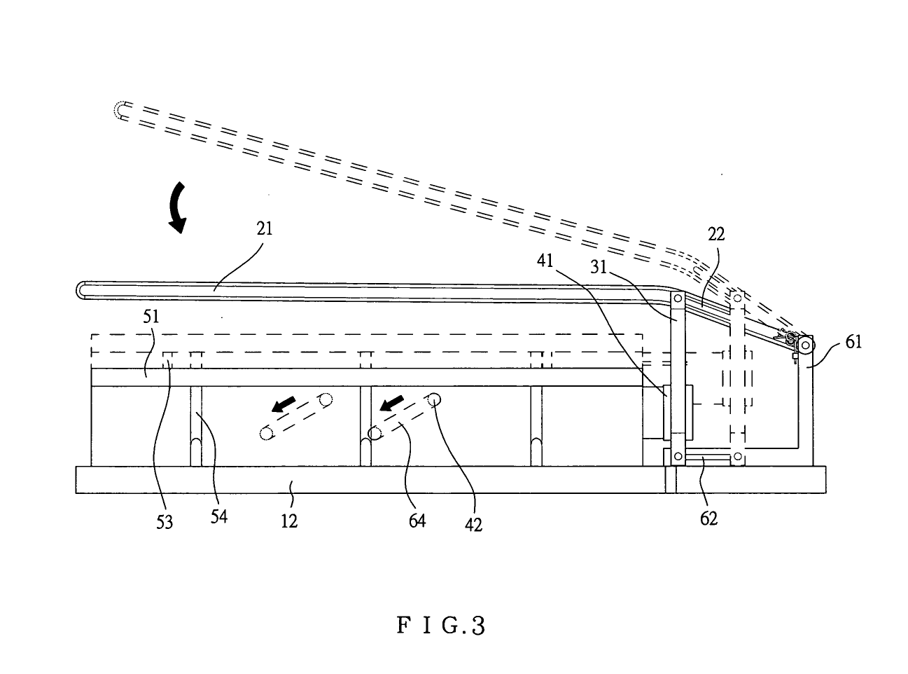

FIG. 3 is a schematic illustration showing operations of the invention. When the handle is not used, one end of the handle rises to keep a predetermined distance from and an angle with the casing. The handle (21) being pressed down also moves the push rod (41) transversely. Also, a punching post or punching posts (54) can penetrate through an accommodating hole or accommodating holes (65) to finish the punching operation when the push rod (41) moves the tool shelf (51) vertically downward due to the combination relationship between the slide rod (31) and the push rod (41).

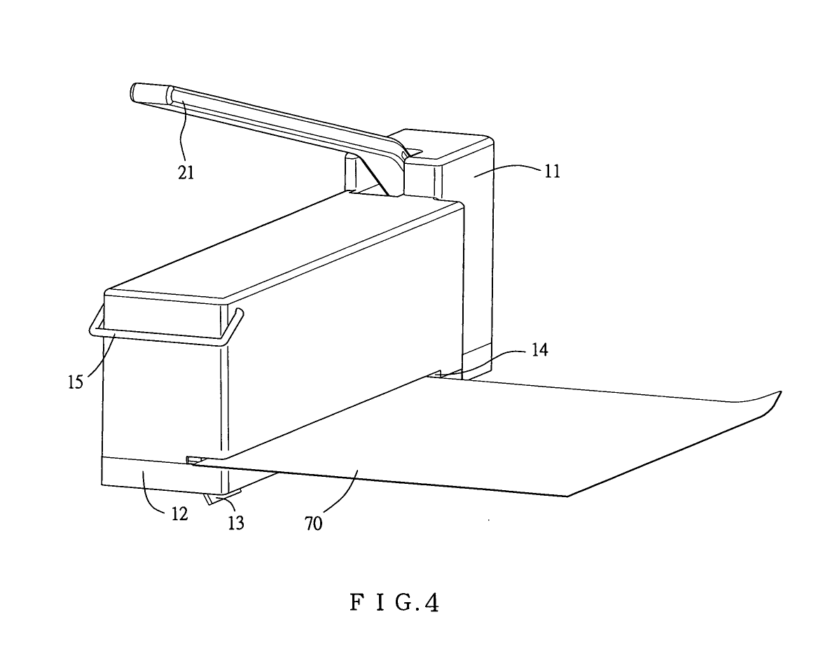

FIG. 4 is a first schematic illustration showing the embodiment of the invention. Furthermore, as shown in FIG. 4, the clearance in a gap (14) between the casing (11) and the bottom cover (12) may accommodate several sheets (70). When the sheets are inserted into the gap (14), the sheets can be correctly aligned with the accommodating hole (65) by pressing the sheets against the cutting edge of the casing (11). In addition, the gap (14) of the casing (11) may be designed to effectively align the accommodating hole (65) with the sheets (70) without any other pressing or engaging mechanism. In addition, paper flakes after the sheets are punched fall into the chamber of the bottom cover (12). Thus, the paper flakes in the bottom cover (12) may be removed after a paper flake cover (13) is opened, and the overall utility and convenience can be significantly enhanced.

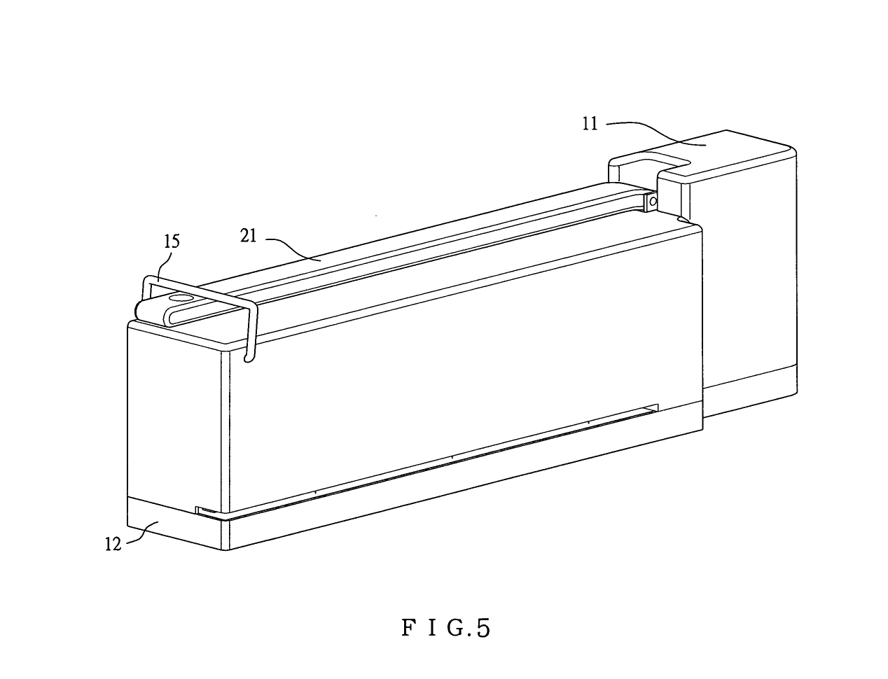

FIG. 5 is a second schematic illustration showing the embodiment of the invention. As shown in FIG. 5, the casing (11) has a loop (15). When the hole punch is not used, the handle (21) may be pressed to the position where the handle (21) is parallel to the casing (11), and the loop (15) locks the handle (21). The provision of the loop (15) can effectively reduce the space for package, reduce the material waste, facilitate the storage, and reduce the waste in the storage space. Thus, the economic value and utility thereof can be greatly enhanced.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A hole punch structure, comprising a casing, a bottom cover, a paper flake cover, a longitudinal handle, a slide rod, a push rod, a tool shelf and a base, wherein:
the casing has a top portion having a space for the handle to be pressed to-and-fro, and has one end on which a loop for locking the handle is mounted;
the bottom cover is disposed under the casing and is formed with a plurality of accommodating holes;
the paper flake cover is mounted onto a bottom portion of the bottom cover;
the handle has one end, which rises when the handle is not used, the other end connected to the base through a stationary shaft, and a lateral side formed with a displacement groove, and the stationary shaft passes through a top portion of the slide rod and is combined with the handle through the displacement groove;
the slide rod has a lateral side formed with an engaging slot, the push rod and the slide rod are combined together through the engaging slot, and the stationary shaft passes a bottom portion of the slide rod and is connected to the displacement groove of the base;
the push rod has a top portion formed with a slit, through which the tool shelf is pushed to move vertically downward, and the push rod has a lateral side formed with a plurality of circular projections and may be moved to-and-fro in a restricting slot of the base;
the tool shelf has a lateral side on which a plurality of punching posts and a plurality of vertical rectangular projections are disposed, the tool shelf is connected to a rectangular slot of the base through the rectangular projections, the tool shelf further has the other lateral side formed with a chamber, the push rod is disposed in the chamber, and the slit of the push rod moves the engaging slot of the tool shelf vertically downward;
the base is disposed above the bottom cover and is formed with a plurality of accommodating holes, the base may be connected to the handle and the slide rod through the stationary shaft, the base is further formed with the restricting slot and the rectangular slot so that the circular projections of the push rod and the rectangular projections of the tool shelf may be combined together and provide a restricting and aligning effect to move the tool shelf vertically downward; and
when one end of the handle is pressed, the slide rod is pushed to move transversely according to connection relationships between the stationary shaft and the handle and the base so that the push rod connected to the slide rod is moved, and the slit of the push rod pushes the engaging slot of the tool shelf so that the tool shelf is pressed vertically downward to achieve an effect of punching holes when the punching posts pass through the accommodating holes.

2. The hole punch structure according to claim 1, wherein a mounting projection and a pressing rod are disposed on the lateral side of the handle, and a torsional spring is mounted on the mounting projection and has one end tightly pressing against the pressing rod.

3. The hole punch structure according to claim 1, wherein a wear-resistant rotatable shaft is fit with the stationary shaft of the slide rod to make the slide rod slide more smoothly.
